(19) United States
(12) Patent Application Publication
(10) Pub. No.: US 2009/0079680 A1
(43) Pub. Date: Mar. 26, 2009

(54) DUAL-VIEW DISPLAY DEVICE

(75) Inventor: Ken YAGIURA, Tottori (JP)

Correspondence Address: HARNESS, DICKEY & PIERCE, P.L.C., P.O. BOX 828, BLOOMFIELD HILLS, MI, 48303, US

(73) Assignee: EPSON IMAGING DEVICES CORPORATION, Azumino-shi (JP)

(21) Appl. No.: 12/181,514

(22) Filed: Jul. 29, 2008

(30) Foreign Application Priority Data
Sep. 26, 2007 (JP) 2007-248573

(51) Int. Cl. G09G 3/36

(52) U.S. Cl. 345/87

(57) ABSTRACT

A method for compensating light leakage caused by slit diffraction in a dual-view display device by making use of a light blocker with slits is provided. A dual-view display device includes: a display that makes a first image and a second image of an input composite image visible in corresponding different viewing directions with a light blocker with slits, the composite image being arranged alternately with subpixels of the first image and subpixels of the second image, the first image being represented by pixels each composed of at least three subpixels of RGB, and the second image being represented by pixels each composed of at least three subpixels of RGB; and a compensation unit that compensates a gradation scale of a target subpixel to be compensated based on a gradation scale of the same color subpixel of adjacent pixel of the target subpixel.

### BACKGROUND

1. Technical Field

The present invention relates to a dual-view display device that makes the display of two different images visible to corresponding different viewing directions, and more particularly, to a dual-view display device that performs optical crosstalk compensation in addition to electrical crosstalk compensation.

2. Related Art

Featuring lightweight, low-profile and low power consumption, liquid crystal display (LCD) devices are used in many electronic devices. LCD devices are also used in navigation Systems, which display images undesirable for traffic safety, such as images from a TV receiver and DVD video player, to a driver while a vehicle is in operation.

Therefore, a technology that enables the display of a plurality of images on a single display and the perception of different images depending on viewing directions has been developed as disclosed in JP-A-2006-184859, so that an image from a navigator is visible by the driver on the driver's side, while an image from a TV receiver or DVD video player is visible by the front passenger on the passenger's side. One of the technologies that enable the perception of different images depending on viewing directions is provided using a light-blocking pattern created by a liquid crystal shutter. The technology that enables the perception of different images depending on viewing directions may be applied to not only navigation systems but also other electronic devices. For example, FIG. 6 included in JP-A-2005-91561 illustrates that neither of the users facing each other with an LCD device between them sees reversed letters on the display.

FIG. 7 is a diagram showing a mechanism that ensures the dual-view display by a dual-view display device 50. A first image is provided from a first subpixel array 51a through apertures 55 of a light blocker 53 to a first viewing area A that is in the left viewing direction. At this time, since a second image provided from a second subpixel array 51b is blocked by light-blocking parts 54 of the light blocker 53, the second image is invisible from the first viewing area A.

On the other hand, the second image is provided from the second subpixel array 51b through slits (apertures) 55 of the light blocker 53 to a second viewing area B that is in the right viewing on. At this time, since the first image provided from the first subpixel array 51a is blocked by the light-blocking parts 54 of the light blocker 53, the first image is invisible from the second viewing area B. Accordingly, the dual-view display provides the first image to the first viewing area A and the second image to the second viewing area B.

Such a dual-view display device 50, arranged between the driver and passenger seats in a vehicle for example, allows a driver to watch images from a vehicle navigation system and a front passenger to watch a DVD or TV, because the driver and passenger have different viewing directions to the dual-view display device 50. In such a dual-view display device, however, subpixels for different images (e.g., subpixels used in a navigation system to display a navigation image in the direction of the driver seat and to display a DVD playback image in the direction of the passenger seat) are adjacent to one another, which causes a large potential difference between subpixels, resulting in crosstalk.

Such a phenomenon will be described with reference to FIGS. 8A and 8B. FIG. 8A is a schematic diagram showing input images and images shown on a dual-view display for both left and right sides. FIG. 8B is a diagram showing a luminance level of each subpixel included in a dual-view display device. In FIGS. 8A and 8B, first viewing positions (on the left side) have a triangle border and second viewing positions (on the right side) have a square border around them so that the right and left sides may be distinguished.

When an input image for the left side is formed of a black box image at the center and a halftone solid image therearound and an input image for the right side is formed only of a halftone solid image as shown in FIG. 8A, for example, the image for the left side is displayed as input on a dual-view display, but crosstalk occurring in the image for the right side causes a change of luminance in an area that corresponds to the area occupied by the black box image for the left side to take place.

In this instance, the luminance level of each subpixel is shown as FIG. 8B. On a dual-view display, no change in luminance level is observed in the halftone solid area in both of the input images for the left and right sides, but larger difference between voltages applied to a pixel electrode for the left side and its adjacent pixel electrode for the right side arises in the black solid area in the input image for the left side. Accordingly, the luminance of subpixels for the right side is made lower than that corresponding to the halftone solid image as shown in an arrow in FIG. 8B (and may be made higher according to an image to be displayed), which causes a change of luminance in the area whose shape is similar to the black solid area for the left side to occur in the display area for the right side. Such a phenomenon on the dual-view display is called horizontal crosstalk.

In order to compensate such crosstalk, a method for compensating a gradation scale of a subpixel according to a gradation scale of its adjacent subpixel with a lookup table (LUT) containing compensation scales corresponding to a gradation scale of a subpixel and a gradation scale of its adjacent subpixel has been devised as disclosed in JP-A-2006-23710.

A dual-view display device including a light blocker with slits, however, experiences light diffraction through the slits. FIG. 9 is a diagram showing crosstalk caused by such diffraction. A subpixel R1. 2B for the right viewing direction, for example, is entered into a subpixel L1. 1B for the left viewing direction by slit diffraction. Seen from the left viewing direction, the slit for the subpixel R1. 2B has a slightly brighter edge on its left side.

Accordingly, not only is electrical crosstalk caused by the difference of pixel voltages between the subpixel L1. 1B for the left viewing direction and its adjacent subpixel R1. 2R but also optical crosstalk is caused by diffraction of light from the subpixel R1. 2B of the same color as the subpixel L1. 1B included in its adjacent pixel that occurs.

Although JP-A-2006-23710 describes compensation of optical crosstalk caused by a sheet polarizer based on adjacent subpixels, JP-A-2006-23710 does not involve a dual-view display device nor disclose optical crosstalk compensation based on subpixels of the same color included in adjacent pixels. In a dual-view display device, subpixels of the same color included in adjacent pixels that have light leakage from one another are different images of different types and profoundly affected by light leakage.

### SUMMARY

An advantage of some aspects of the invention is to provide a method for compensating light diffraction through slits that is a problem peculiar to a dual-view display device.

A dual-view display device according to a first aspect of the present invention includes: a display that makes a first image and a second image of an input composite image visible in corresponding different viewing directions with a light blocker with slits, the composite image being arranged alternately with subpixels of the first image and subpixels of the second image, the first image being represented by pixels each composed of at least three subpixels of RGB, and the second image being represented by pixels each composed of at least three subpixels of RGB; and a compensation unit that compensates a gradation scale of a subpixel targeted for compensation based on a gradation scale of a subpixel in a pixel adjacent to and of the same color as the target subpixel.

Accordingly, by compensating not adjacent subpixels but subpixels of the same color in adjacent pixels, leakage of light from an image for a different viewing direction to a dual-view display device that is caused by slit diffraction can be compensated

The above dual-view display device may also include a first lookup table (first LUT) that stores a compensation table dealing with a gradation scale of a target subpixel for compensation and a gradation scale of the same color subpixel of adjacent pixel of the target subpixel. The compensation unit may add compensation data extracted from the first LUT to the gradation scale of the subpixel targeted for compensation.

Since the dual-view display device performs a dual-view compositing process, image processing has to be performed in a short period of time. Such a use of the first LUT can avoid calculation related to a gamma 2.2 and image processing can be made speedily.

The above dual-view display device may also include a second LUT that stores a second compensation table dealing with a gradation scale of a subpixel targeted for compensation and a gradation scale of a subpixel adjacent to the target subpixel. The compensation unit may add second compensation data extracted from the second LUT and compensation data extracted from the first LUT to the gradation scale of the subpixel targeted for compensation.

Accordingly, electrical and optical crosstalk is compensated at the same time, whereby image processing can be performed speedily.

### BRIEF DESCRIPTION OF THE DRAWINGS

The invention will be described with reference to the accompanying drawings, wherein like numbers reference like elements.

FIG. 1 is a block diagram showing main part of a dual-view display device according to an embodiment of the present invention.

FIG. 2 is a diagram showing an electrical compensation table stored in an electrical LUT.

FIG. 3 is a diagram showing an optical compensation table stored in an optical LUT.

FIG. 4 is a diagram showing a pixel arrangement included in an LCD panel.

FIG. 5 is a diagram showing image composition for each of the two viewing directions and a checkered subpixel arrangement.

FIG. 6 is a diagram showing an example of specific compensation.

FIG. 7 is a sectional view showing an example of a related-art liquid-crystal dual-view display device.

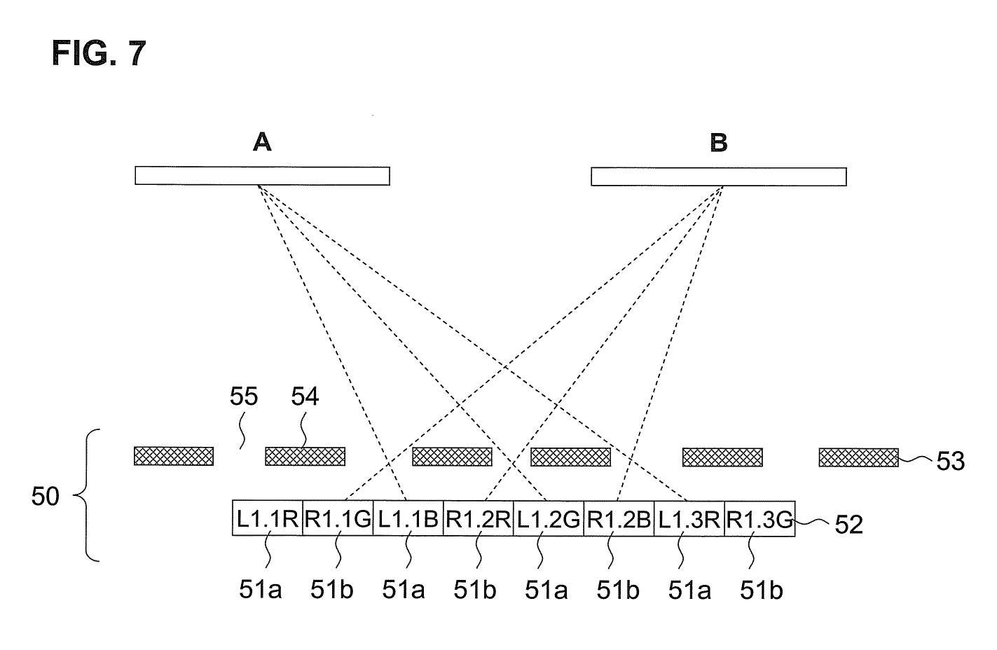

FIG. 8A is a schematic diagram showing input images and images shown on a dual-view display for both left and right sides. FIG. 8B is a diagram showing a luminance level of each subpixel included in the liquid-crystal dual-view display device.

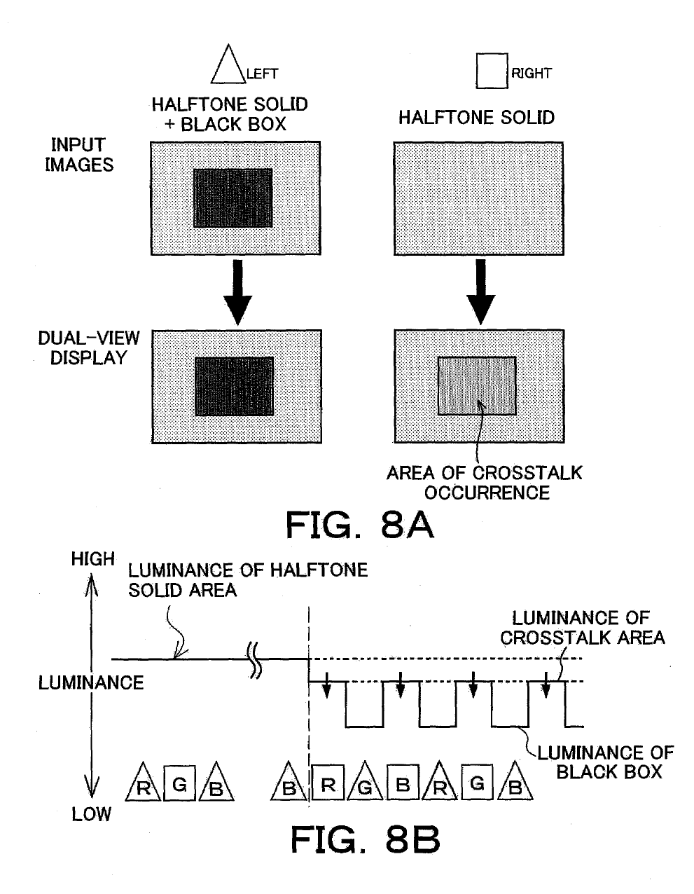

FIG. 9 is a diagram showing light leakage caused by slit diffraction.

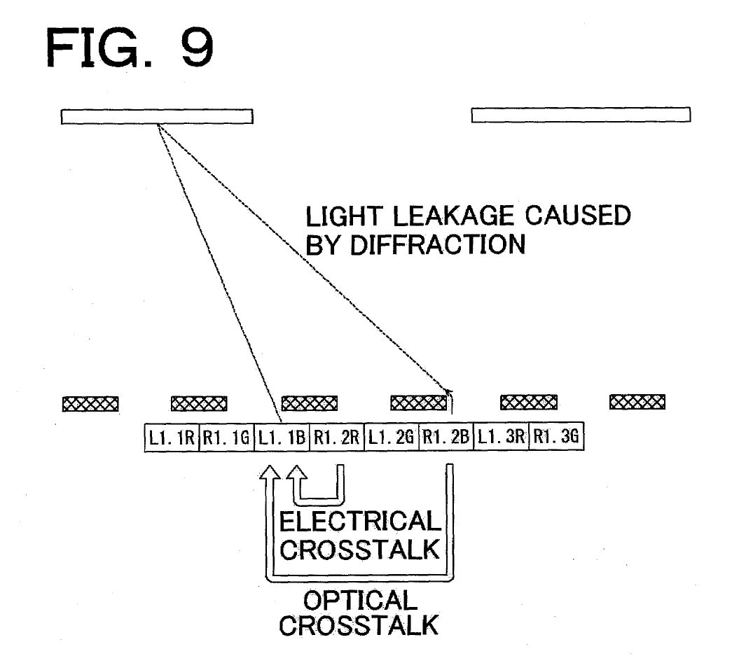

### DESCRIPTION OF EXEMPLARY EMBODIMENTS

Preferred embodiments of the invention will be described hereinafter with reference to the accompanying drawings. The embodiments described and illustrated hereinafter, however, are merely examples of a display device to embody the spit and scope of the invention, are not intended to limit the invention thereto, and may be equally applied to other embodiments included in the appended claims.

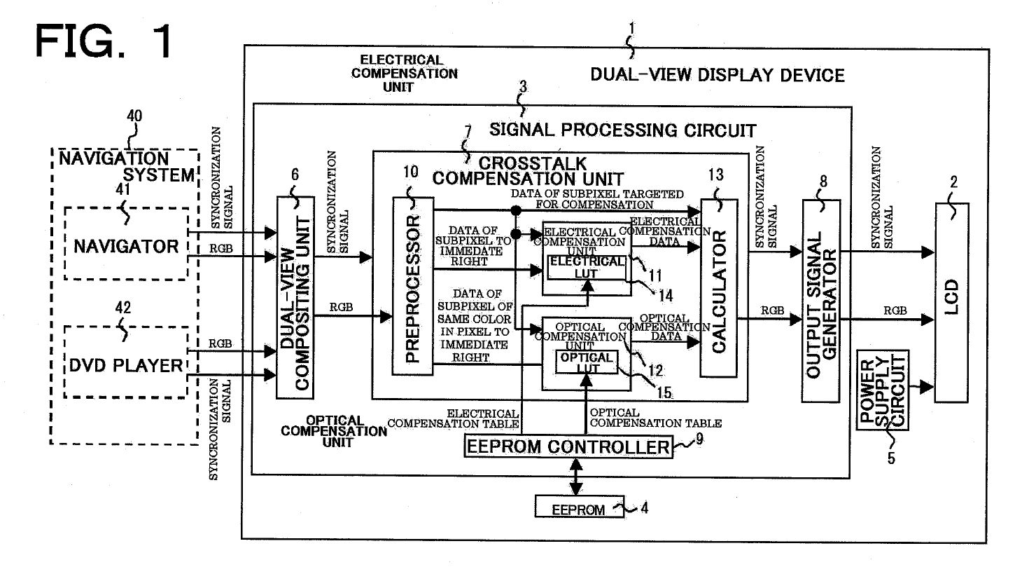

FIG. 1 is a block diagram showing main part of a dual-view display device according to an embodiment of the present invention. The solid lines in FIG. 1 indicate a dual-view display device 1. The broken lines in FIG. 1 indicate a navigation system 40 wherein the dual-view display device 1 is embedded.

The dual-view display device 1 shown in FIG. 1 includes a liquid crystal display (LCD) 2, a signal processing circuit 3 that provides a dual-view compositing process and crosstalk compensation to two source images (a navigation image and a DVD image) sent from the navigation system 40 and sends the output to the LCD 2, an EEPROM 4 that stores various data needed for the operation of the signal processing circuit 3, and a power supply circuit 5 that supplies electric power to the LCD 2.

The signal processing circuit 3 includes a dual-view compositing unit 6 that composites two source images, a crosstalk compensation unit 7 that performs crosstalk compensation, an output signal generator 8 that controls the polarity and timing of a signal compensated by the crosstalk compensation unit 7 for the display on the LCD 2, and an EEPROM controller 9 that controls inputs to and outputs from the EEPROM 4.

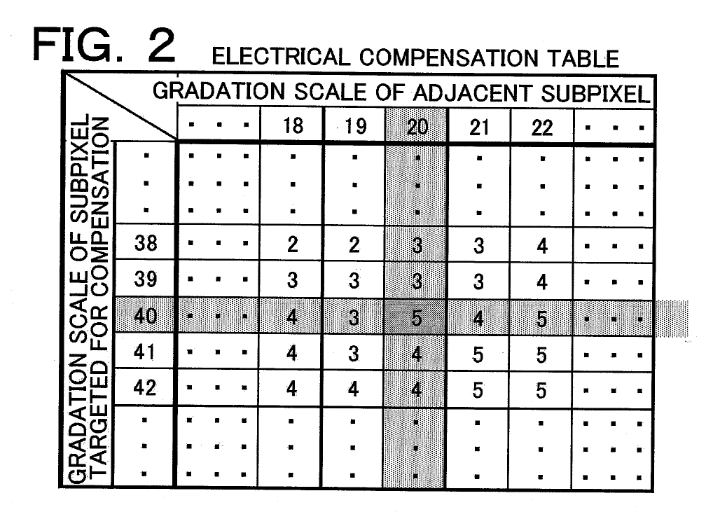

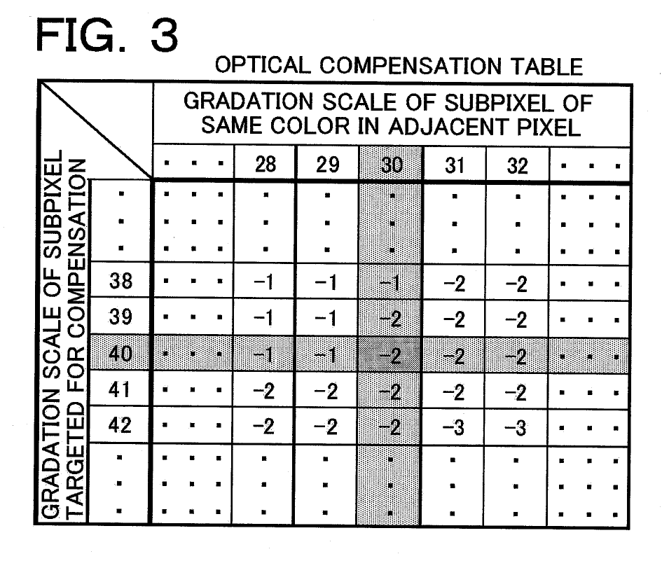

The crosstalk compensation unit 7 includes a preprocessor 10, an electrical compensation unit 11, an optical compensation unit 12 and a calculator 13. The preprocessor 10 sends the electrical compensation unit 11, optical compensation unit 12 and calculator 13, necessary data included in an image signal sent from the dual-view compositing unit 6. The electrical compensation unit 11 includes an electrical LUT 14 storing an electrical compensation table (shown in FIG. 2) provided by the EEPROM controller 9, and inputs from the preprocessor 10 data of a target subpixel for compensation and data of right adjacent subpixel to extract electrical compensation data from the electrical compensation table stored in the electrical LUT 14. The optical compensation unit 12 includes an optical LUT 15 storing an optical compensation table (shown in FIG. 3) provided by the EEPROM controller 9, and inputs from the preprocessor 10 data of a subpixel targeted for compensation and data of the the same color subpixel of right adjacent pixel to extract optical compensation data from the optical compensation table stored in the optical LUT 15. The calculator 13 adds compensated electrical data extracted by the electrical compensation unit 11 and compensated optical data extracted by the optical compensation unit 12 to a subimage targeted for compensation that is input from the preprocessor 10.

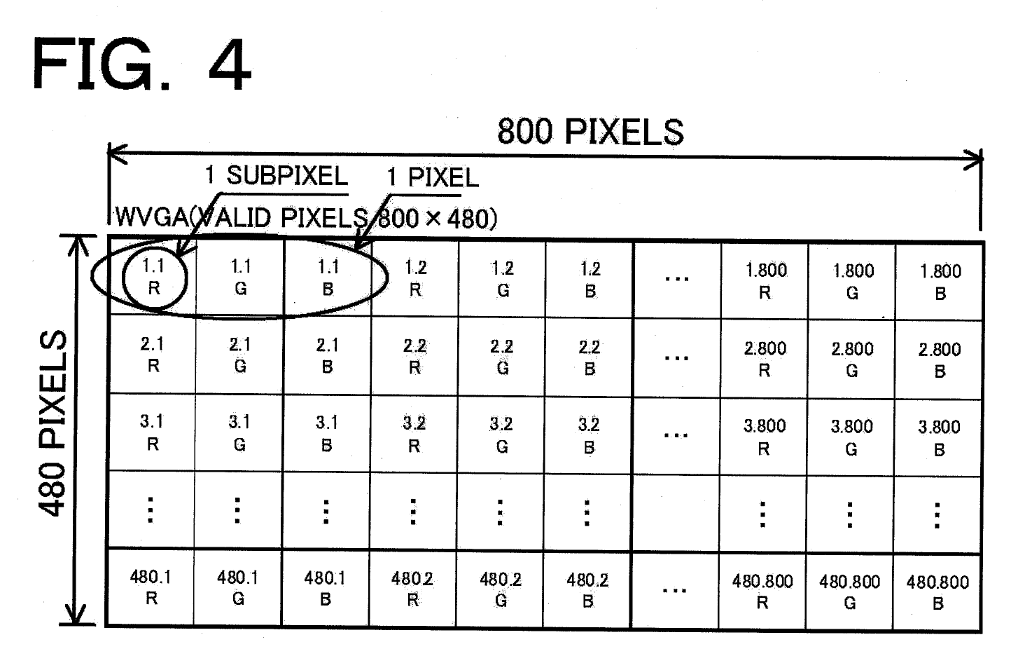

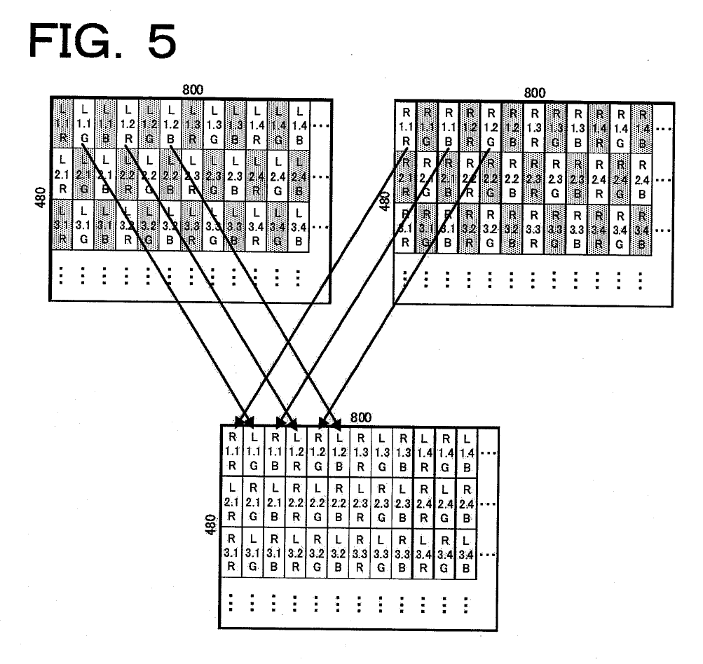

FIG. 4 is a diagram showing pixels included in the LCD 2. The LCD 2 is a WVGA color display with 800 pixels in the source line direction (horizontal direction) and 480 pixels in the gate line direction (vertical direction). One pixel is composed of three subpixels, i.e., RGB subpixels. The LCD 2 includes a light blocker (liquid crystal shutter) that has light blocking parts arranged in a checkered light-blocking pattern (similar to a chessboard having alternately black and white squares on it, as shown in the right and left[R/L] subpixel arrangement contained in FIG. 5) for subpixels. One checkered pattern of subpixels is visible only from the right side (the driver's side in Japan) and the other is visible only from the left side (the passengers side in Japan). For example, navigation is visible from the right side, and a DVD is visible from the left side. A subpixel included in an input image has six-bit gradation data. RGB luminance is measured by 64 a gradation scale of from 0 to 63. Since the drive control for the luminance of the LCD 2 is given by a gradation scale, only integers may be assigned for a gradation scale. The period of one frame (800-times-480 pixels), i.e., the frame period, is 60 Hz. The apertures in the checkered pattern are slits, which allow light diffraction, resulting in light leakage.

The EEPROM 4 stores the electrical compensation table shown in FIG. 2 and an optical compensation table shown in FIG. 3. The electrical compensation table stores the electrical compensation scale for every gradation scale of a target subpixel for compensation corresponding to every gradation scale of its adjacent subpixel. The compensation scales have been obtained by experiments. The optical compensation table stores an optical compensation scale for every gradation scale of a target subpixel for compensation corresponding to every gradation scale of the same color subpixel of adjacent pixel. The compensation scales have been obtained by experiments. When the power switch (not shown) of the navigation system is turned on, the EEPROM controller 9 transfers the electrical compensation table and optical compensation table from the EEPROM 4 to the electrical LUT 14 and to the optical LUT 15 respectively.

Image processing for a dual-view display device under the above configuration will be described.

As shown in FIG. 5, the dual-view compositing unit 6 selects subpixels from 800-times-480 pixels constituting a navigation image input from a navigator 41 included in the navigation system 40 and 800-times-480 pixels input from a DVD player 42 to form a checkered pattern for compositing one 800-times-480-pixel image.

The preprocessor 10 included in the crosstalk compensation unit 7 outputs to the electrical compensation unit 11, optical compensation unit 12 and calculator 13 data (six-bit gradation data) of a subpixel targeted for compensation contained in the composite image input from the dual-view compositing unit 6, outputs to the electrical compensation unit 11 data of the right adjacent subpixel, and outputs to the optical compensation unit 12 data of the same color subpixel of target subpixel of right adjacent pixel.

The electrical compensation unit 11 extracts electrical compensation data corresponding to the data of the subpixel targeted for compensation and the data of the subpixel to its immediate right, from the electrical compensation table stored in the electrical LUT 14. The optical compensation unit 12 extracts optical compensation data corresponding to the data of the subpixel targeted for compensation and the data of the subpixel of the same color as the target subpixel included in the pixel on its immediate right, from the optical compensation table stored in the optical LUT 15. The calculator 13 adds electrical compensation data extracted by the electrical compensation unit 11 and optical compensation data extracted by the optical compensation unit 12 to a subimage targeted for compensation that is input from the preprocessor 10.

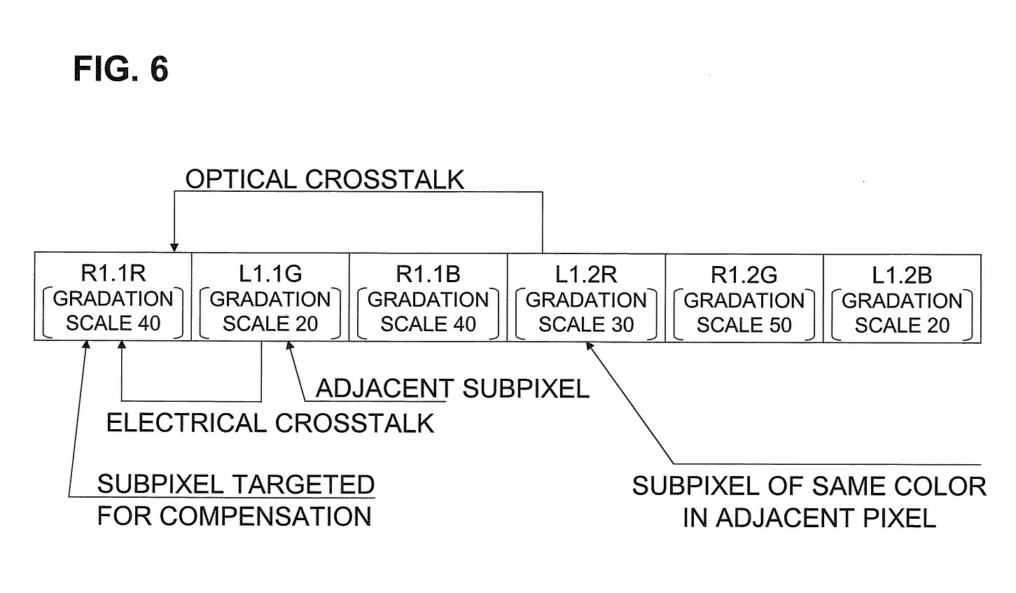

Assuming that a target subpixel R1. 1R for compensation has a gradation scale 40, that the right adjacent subpixel L1. 1G has a gradation scale 20, and that the same color subpixel L1. 2R of right adjacent pixel has a gradation scale 30 for example, as shown in FIG. 6. “L” in L1. 2R represents the left, “1.2” therein represents the second pixel in the first line, and “R” therein represents RED.

According to the electrical compensation table shown in FIG. 2, the electrical compensation scale is 5 when a subpixel targeted for compensation has a gradation scale 40 and the subpixel to its immediate right has a gradation scale 20. According to the optical compensation table shown in FIG. 3, the optical compensation scale is −2 when a subpixel targeted for compensation has a gradation scale 40 and the same color subpixel of right adjacent pixel has a gradation scale 30. The gradation scale of the subpixel targeted for compensation after compensation, therefore, is 40+5−2=43.

A composite image that has undergone such electrical and optical crosstalk compensation is displayed on the LCD 2 via the output signal generator 8 so as to be visible to both different viewing directions.

As described above, the compensation method according to the invention is based on not adjacent subpixels but subpixels of the same color in adjacent pixels, so that leakage of light from an image for a different viewing direction to a dual-view display device that is caused by slit diffraction may be compensated Since adjacent pixels on a dual-view display are images for different viewing directions, the compensation of such light leakage has a significant influence on the visual perception of a dual-view display

Using an optical LUT 15 storing an optical compensation table dealing with the gradation scale of a target subpixel for compensation and the gradation scale of the same color subpixel of adjacent pixel, the compensation method is the addition of optical compensation data extracted from the optical LUT 15 to the gradation scale of the subpixel targeted for compensation. Such a use of an LUT allows the avoidance of calculation related to a gamma 2.2 and speedy image processing.

Using an electrical LUT 14 storing an electrical compensation table dealing with the gradation scale of a subpixel targeted for compensation and the gradation scale of its adjacent subpixel, the compensation method is also the addition of electrical compensation data extracted from the electrical LUT 14 and optical compensation data extracted from the optical LUT 15 to the gradation scale of the subpixel targeted for compensation. Accordingly, electrical and optical crosstalk is compensated at the same time, whereby image processing can be performed speedily.

Although the light-blocking pattern mentioned above is a checkered pattern, the invention may be applied to a striped pattern or other light-blocking patterns.

Although the compensation according to the invention is based on a pixel to the right, compensation may be based on an adjacent pixel to a different direction according to an image processing direction or light-blocking pattern.

The invention may be applied to a pixel composed of four subpixels, i.e. RGB and white subpixels.

Although the embodiment described above uses a liquid crystal panel, the invention may be applied to an organic electroluminescence device (organic EL device), plasma display device, or other electrooptic devices that may accommodate the drive system according to the invention.

The invention may be applied to a multi-view display device that displays three or more frames using slits.

What is claimed is:

1. A dual-view display device comprising:
a display that makes a first image and a second image of an input composite image visible in corresponding different viewing directions by a light blocker with slits, the composite image being arranged alternately with subpixels of the first image and subpixels of the second image, the first image being represented by pixels each composed of at least three subpixels of RGB, and the second image being represented by pixels each composed of at least three subpixels of RGB; and
a compensation unit that compensates a gradation scale of a target subpixel to be compensated based on a gradation scale of a same color subpixel of adjacent pixel of the target subpixel.

2. The dual-view display device according to claim 1, further comprising:
a first lookup table (first LUT) that stores a compensation table dealing with gradation scales of the target subpixel to be compensated and gradation scales of the same color subpixel of adjacent pixel of the target subpixel; wherein
the compensation unit adds a compensation data extracted from the first LUT to the gradation scale of the target subpixel to be compensated.

3. The dual-view display device according to claim 2, further comprising:
a second LUT that store a second compensation table dealing with gradation scales of a target subpixel to be compensated and gradation scales of adjacent subpixel of the target subpixel; wherein
the compensation unit adds a second compensation data extracted from the second LUT and a compensation data extracted from the first LUT to the gradation scale of the target subpixel to be compensated.
